(19) United States
(12) Patent Application Publication
(10) Pub. No.: US 2005/0104995 A1
(43) Pub. Date: May 19, 2005

(54) O-ring camera lens attachment for high precision axial alignment, adjustable focal length, and permanent position

(76) Inventors: Joseph J. Spryshak, Hartland, MI (US); Kevin S. Jump, Bloomfield Hills, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/715,732

(22) Filed: Nov. 18, 2003

(51) Int. Cl. H04N 5/225

(52) U.S. Cl. 348/360

(57) ABSTRACT

A camera assembly generally includes a camera housing and a lens barrel. The camera housing has a receptacle portion that has a bore with an inside diameter. The lens barrel has a mating shaft portion with an outside diameter that is smaller than the inside diameter of the bore of the receptacle portion. The bushings are positioned around the mating shaft portion of the lens barrel to create an interference fit between the lens barrel in the bore of the receptacle portion to axially align the lens barrel with the receptacle portion.

### CROSS-REFERENCE TO RELATED APPLICATIONS

This application claims priority from the following patent applications, which are hereby incorporated by reference in their entirety: “SYSTEM AND METHOD FOR CONFIGURING AN IMAGING TOOL”, Ser. No. 10/457,625 filed Jun. 9, 2003; and “DECISION ENHANCEMENT SYSTEM FOR A VEHICLE SAFETY RESTRAINT APPLICATION” filed Nov. 7, 2003

### BACKGROUND OF THE INVENTION

Camera users are demanding increased precision, aiming and focusing abilities by their cameras. Such focusing abilities of a camera are dependent on the attachment of the lens to the camera housing. The current technology for attaching the lens to the camera housing uses a threaded barrel lens that screws into a female receptacle of the camera housing. This attachment means, however, provides limited capability for axial alignment between the camera housing and the barrel. Specifically, axial alignment of the lens barrel and the camera housing depends on numerous machining and manufacturing processes. These manufacturing processes include the ability of the manufacturing equipment to bore a center hole in the camera housing. Additionally, the threads which allow the barrel to be threaded into the female receptacle of the camera housing must be machined accurately. The lens barrel, itself, must additionally be machined properly. Lastly, the threads cut on the barrel itself must be machined accurately. Each of these factors stacks up to create tolerance variations in the axial alignment between the lens barrel and the camera housing that drastically compromises the ability of the camera to provide precision focusing and aiming. This accuracy is further compromised by the required clearance between the pitch diameter of the male and female components of the lens barrel and the camera housing respectively.

The focusing ability of a camera also relies on the threaded attachment of the lens barrel to the camera housing. The current technology for focusing a camera is to rotate the camera lens in an attempt to focus the camera. This procedure also uses the same threaded attachment means as described above. Specifically, a threaded barrel is rotated in the camera housing such that the threads of the lens barrel engage the threads of the camera housing to move the lens barrel in and out to accomplish focusing. To enable the lens barrel to properly and easily rotate in the camera body, sufficient clearance must be provided between the threads of the lens barrel and the lens of the camera housing, to allow ease of rotation. Such clearance additionally creates difficulty in axially aligning the lens barrel with the camera body. The present invention was developed in light of these and other drawbacks.

### BRIEF DESCRIPTION OF THE DRAWINGS

The present invention will now be described, by way of example, with reference to the accompanying drawings, in which:

FIG. 1 is a perspective exploded view of a camera assembly according to an embodiment of the present invention;

FIG. 2 is a schematic view of a lens barrel according to an embodiment of the present invention;

FIG. 3 is a schematic view of a lens barrel assembled to a receptacle portion according to an embodiment of the present invention;

FIG. 4 is a schematic view of a lens barrel assembled to a receptacle portion according to an embodiment of the present invention;

FIG. 5 is a schematic view of a lens barrel assembled to a receptacle portion according to an embodiment of the present invention; and

FIG. 6 is a schematic view of a lens barrel assembled to a receptacle portion according to an embodiment of the present invention.

### DETAILED DESCRIPTION

The present invention generally provides a mounting structure for mounting a lens barrel in a camera housing that includes providing a lens barrel that has a portion which is positioned within an inside diameter of a receptacle of the camera housing. A bushing or O-ring material is positioned between the portion of the lens barrel and the inside diameter of the receptacle.

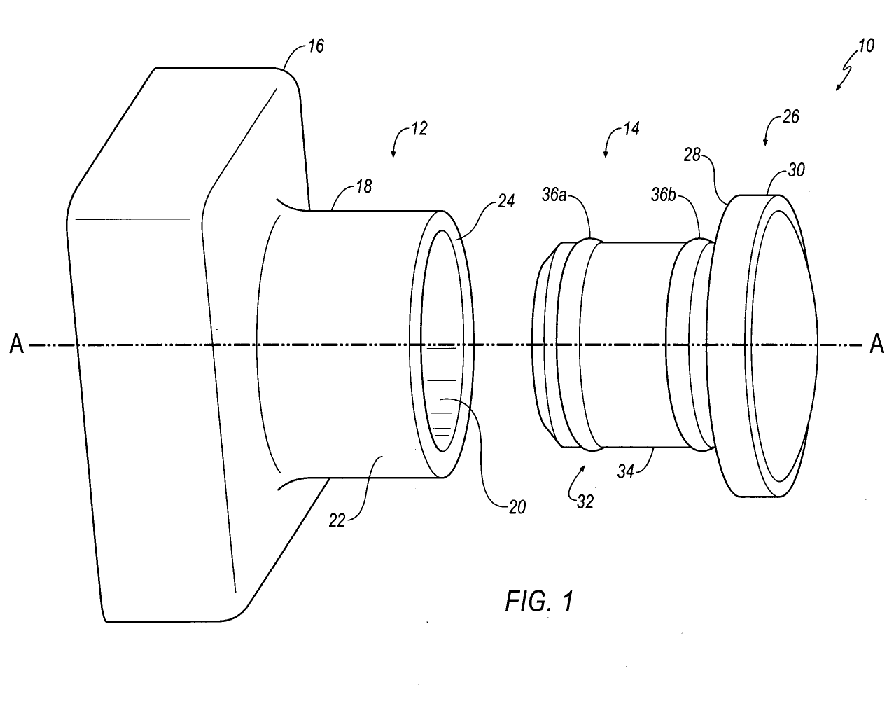

Referring now to FIG. 1, an embodiment of the present invention is shown and described. In FIG. 1, a camera assembly 10 is shown generally comprising a camera housing 12 and a lens barrel 14 both extending along an axis A-A when assembled in the matter discussed below. The camera housing 12 includes a body portion 16 integrally formed with a receptacle portion 18. Although the body portion 16 is shown as being integrally formed with the receptacle portion 18, one skilled in the art will readily recognize that many other attachment means or processes may be effectuated to form the camera housing 12. The body portion 16 generally includes the optics, mechanics and other functional features that allow the camera assembly 10 to operate. The receptacle portion 18 includes an inside diameter 20 and an outside diameter 22.

The lens barrel 14 includes an end area 26 that has a mating face 28 and an end area outer diameter 30. In one embodiment, the end area outer diameter 30 is larger than the inside diameter 20 of the receptacle portion 18. This sizing allows the mating face 28 to act as a stop against the end face 24 in the instance that the lens barrel 14 is pressed too far toward receptacle portion 18.

The remainder of lens barrel 14 includes mating shaft portion 32 and bushing portions 36a and 36b. The mating shaft portion 32 has a shaft outer diameter 34 that is slightly smaller than the inside diameter 24 for reasons which will be discussed in greater detail below.

The bushing portions 36a and 36b can be in the form of elastic material such as a rubber O-ring or other suitable material. It should also be noted that, although two bushing portions 36a and 36b are shown, a number of bushing portions may be used such as three bushing portions, and the present invention is not limited to the examples depicted in the Figures or described herein.

The O-ring or bushing material of 36a and 36b provides a spring constant that aligns the lens barrel 14 within the receptacle portion 18 of the camera housing. The bushing material of bushing portions 36a and 36b may be any elastic material such as rubber. As an electromagnetic shielding measure, the bushing material 36a and 36b can be specified with an electrically conductive filler to electrically close the gap between the receptacle portion 18 and the lens barrel 14. In an embodiment, the bushing portions 36a and 36b are the only elements positioned between the lens barrel 14 and the receptacle portion 18. As such, the stacked up tolerances as discussed in the previous section with respect to a threaded attachment are eliminated by replacing the threaded attachment and the tolerance sensitive machining processes with one single elastic element such as, the bushing portions 36a and 36b. Additionally, the bushing portions 36a and 36b apply an even elastic pressure on the lens barrel 14. This elastic pressure and the friction applied by the bushing portions 36a and 36b prevent the lens barrel 14 from falling out of the receptacle portion 18. The elastic pressure and friction of the bushing portions 36a and 36b is, however, sufficiently small to allow the lens barrel 14 to be moved in the receptacle portion 18.

Additionally, the elastic properties of the bushing portions 36a and 36b apply an equal elastic force around the periphery of lens barrel 14 to position the lens barrel 14 on center of the axis A-A as defined by the receptacle portion 18.

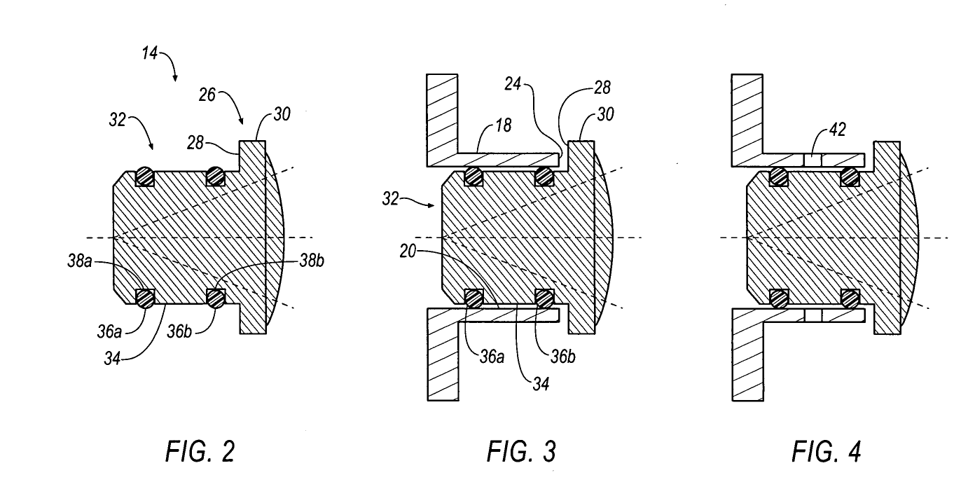

Referring now to FIG. 2, bushing portions 36a and 36b are positioned within respective grooves 38a and 38b. Grooves 38a and 38b extend around the circumference of the mating shaft portion 32 and may be machined or formed into the surface of mating shaft portion 32 by any known manufacturing means. It should also be noted that although grooves 38a and 38b are shown as circular in nature, other configurations of both the grooves and the bushing portions may be used such as patches or pads or any other means recognizable by one skilled in the art.

Referring now to FIG. 3, mating shaft portion 32 is shown as being positioned within receptacle portion 18. The grooves 38a and 38b have a depth that allows the bushing portions 36a and 36b to extend to an outside diameter that is slightly greater than shaft outer diameter 34. The resulting outer diameter of bushing portions 36a and 36b is also slightly greater than the inside diameter 20 of the receptacle portion 18. This diameter relationship creates an interference fit between the bushing portions 36a and 36b by allowing the inside diameter 20 of the receptacle portion 18 to be pressed by the elasticity of the bushing portions 36a and 36b. This elasticity also applies an evenly distributed force around the periphery of the lens barrel 14 to press the lens barrel 14 towards a central axis of the receptacle portion 18. This aligns the central axis of the lens barrel 14 with the central axis of the receptacle portion 18. However, the depth of the grooves 38a and 38b and the size of the bushing portions 36a and 36b provide a sufficiently minimal interference fit, such that the lens barrel 14 can be moved in and out of the receptacle portion 18. Accordingly, when it is desired to focus the lens barrel 14, the lens barrel 14 may be slid in and out of receptacle portion 18. This allows the lens barrel 14 to be positioned in any one of an infinite number of positions.

Referring now to FIG. 4, another embodiment of the present invention is shown and described. In FIG. 4, receptacle portion 18 includes an aperture 42 in the receptacle portion 18 which is located between bushing portions 36a and 36b. The aperture 42 allows an adhesive material to be injected between the receptacle portion 18 and the lens barrel 14, to affix a lens barrel 14 in the receptacle portion 18. This affixing has particular application to a camera assembly 10 which does not have focusing features that the user can use. Such applications include, for example, disposable cameras and other similar devices that have a fixed focus, which do not allow a user to activate the focusing features. These features are also particularly useful when the camera assembly 10 is intended to be permanently mounted and focused on a fixed spot. The camera assembly 10 can be precisely focused and then the lens barrel 14 is locked into position using the adhesive material.

With continued reference to FIG. 4, a method for assembling and permanently fixing the lens barrel 14 to the receptacle portion 18 is shown and described. The lens barrel 14 is first inserted into the receptacle portion 18 of the camera housing 12. Due to the interference between bushings 36a and 36b, the mating shaft portion may be pressed into the receptacle portion 18 to squeeze the bushings 36a and 36b, and reduce their outer diameter to allow the mating shaft portion 32 to be inserted into the receptacle portion 18. Next, the lens barrel 14 is adjusted in and out of the receptacle portion 18 until proper focusing is effectuated. Once in position, an adhesive can then be injected into aperture 42. After the adhesive cures, the lens barrel 14 will be unable to move out of focus. It should be noted that injection of the adhesive is optional, and the lens barrel 14 may be left such that it can be adjusted back and forth to adjust focusing by a user of the camera assembly 10.

The adhesive resides in a space defined by bushing portions 36a , 36b, shaft outer diameter 34, and internal diameter 20 of receptacle portion 18. The adhesive cures to rigidly affix mating shaft portion 32 in receptacle portion 18. The adhesive also fills the aperture 42 such that the aperture 42 is not visible for aesthetic reasons.

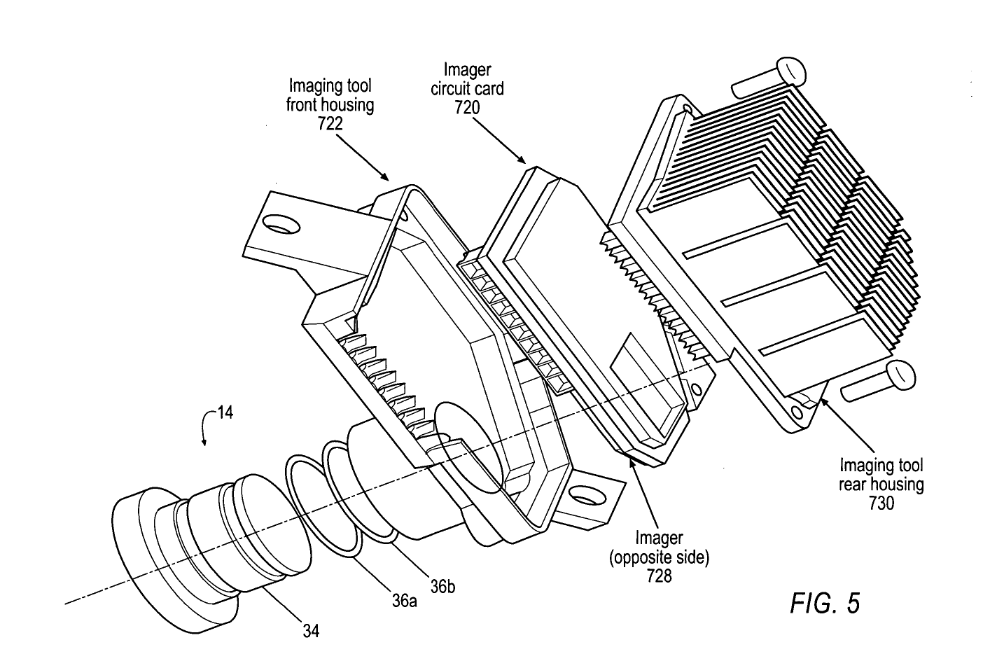

FIG. 5 provides an example of an imaging tool that utilizes camera assembly 10 according to an embodiment of the present invention. Here, the imaging tool includes a manipulatable tab for configuring the imaging tool while it is assembled. In a manipulatable tab of the imaging tool, the imaging tool and its housing components 730 and 722 can be permanently attached before the imaging tool is configured for use by the system 100.

The example in FIG. 5 includes two housing components 722 and 730 and an imager circuit card 720 that includes tabs for configuring the imaging tool while it is assembled. Parts of the imaging tool can be focused and aligned by the movement of “tabs” that are accessible from outside the imaging tool. The tabs can resemble various linear adjustment mechanisms in other devices.

On the left side of the diagram is the camera assembly 10 that includes the various lenses 14 incorporated into the imaging tool. The number and size of lenses can vary widely from embodiment to embodiment. Bushing portions 36a and 36b are used to secure the position and alignment of the lens barrel 34. A front housing component 722 and a rear housing component 730 are ultimately fastened together to keep the imaging tool in a fully aligned and focused position. Between the two housing components is an imager circuit board 720 with the imager 728 on the other side, hidden from view.

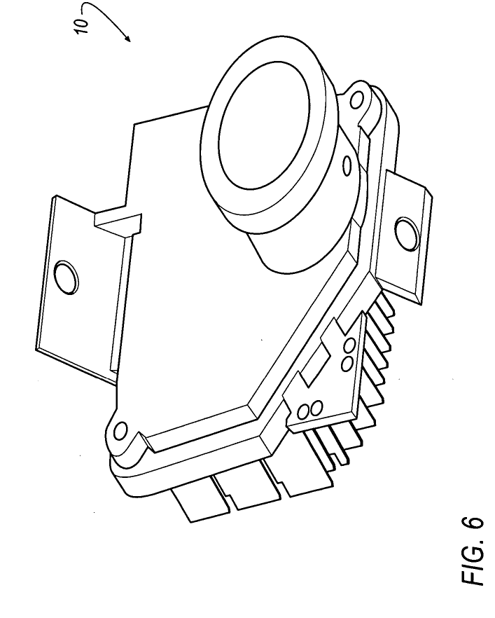

FIG. 6 shows a component diagram illustrating a fully assembled view of the imaging tool 736. The construction of the imaging tool and other features of the present invention are shown in patent application entitled “System and Method for Configuring an Imaging Tool”, assigned to the assignee of the present application, the disclosure of which is hereby incorporated by reference.

As can be seen, the present invention provides an enhanced way of attaching a camera lens to a camera housing. While the present invention has been particularly shown and described with reference to the foregoing preferred and alternative embodiments, it should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element of the equivalent thereof, such claims should be understood to include incorporation of one or more such elements, neither requiring nor excluding two or more such elements.

1. A camera assembly, comprising:
a camera housing having a receptacle portion, wherein the receptacle portion has a bore with an inside diameter;
a lens barrel having an outside diameter and positioned in the bore of the receptacle; and
at least two bushing portions disposed on the outside diameter of the lens barrel;
wherein the outside diameter of the lens barrel is smaller than the inside diameter of the bore of the receptacle portion; and
wherein the bushing creates an interference fit with the inside diameter of the bore of the receptacle to axially align the lens barrel with the receptacle portion.

2. The camera assembly according to claim 1, wherein the lens barrel has at least two grooves in the outside diameter, wherein the bushing portion is positioned in the groove.

3. The camera assembly according to claim 1, wherein the at least two bushing portions comprises:
a first bushing portion; and
a second bushing portion spaced from the first bushing portion along an axis of the lens barrel.

4. The camera assembly according to claim 3, further comprising an adhesive positioned between the first bushing, the second bushing, the outside diameter of the lens barrel, and the inside diameter of the bore of the receptacle portion.

5. The camera assembly according to claim 3, wherein the first bushing portion and a second bushing portion apply a substantially equal elastic force on the lens barrel to align an axis of the lens barrel with an axis of the receptacle.

6. The camera assembly according to claim 1, further comprising an end portion positioned at one end of the lens barrel that is distally located from the receptacle portion, wherein the end has an outside diameter that is greater than the inside diameter of the bore of the receptacle portion such that the end portion is unable to enter the inside diameter of the bore of the receptacle portion.

7. A camera kit comprising:
a camera housing having a receptacle portion, wherein the receptacle portion has a bore with an inside diameter;
a lens barrel having an outside diameter, the lens barrel including:
at least two bushing portions disposed on the outside diameter of the lens barrel; and
wherein the outside diameter of the lens barrel is smaller than the inside diameter of the bore of the receptacle portion; and
wherein the lens barrel is adapted to be positioned in the bore of the receptacle portion, such that the bushing portion creates an interference fit with the inside diameter of the bore of the receptacle portion to axially align the lens barrel with the receptacle portion.

8. The camera kit according to claim 7, wherein the lens barrel has at least two grooves in the outside diameter, wherein the bushing portion is positioned in the groove.

9. The camera kit according to claim 7, wherein the at least one bushing portion comprises:
a first bushing portion; and
a second bushing portion spaced from the first bushing portion along an axis of the lens barrel.

10. The camera kit according to claim 7, further comprising:
an adhesive;
wherein the receptacle portion further comprises an aperture; and
wherein the adhesive is adapted to be injected through the aperture to affix the lens barrel to the camera housing.

11. A lens barrel comprising:
a mating shaft portion having an outside diameter; and
at least two bushing portions disposed on the outside diameter of the mating shaft portion.

12. The lens barrel according to claim 11, wherein the mating shaft portion has at least two grooves in the outside diameter, wherein the bushing portion is positioned in the groove.

13. The lens barrel according to claim 11, wherein the at least two bushing portions comprise:
a first bushing portion; and
a second bushing portion spaced from the first bushing portion along an axis of the mating shaft portion.

14. The lens barrel according to claim 11, further comprising an end portion, wherein the end portion has an outside diameter that is greater than the outside diameter of a remainder of the mating shaft portion.

15. The lens barrel according to claim 11, wherein the mating shaft portion is adapted to be adhered to a camera housing.

16. A method for assembling a lens barrel into a camera housing, comprising:
providing a camera housing having a receptacle portion, wherein the receptacle portion has a bore with an inside diameter;
providing a lens barrel having an outside diameter and at least two bushing portions disposed on the outside diameter of the lens barrel, wherein the outside diameter of the lens barrel is smaller than the inside diameter of the bore of the receptacle portion, wherein an outside diameter of the bushing is larger than an inside diameter of the bore of the receptacle portion;
pressing the lens barrel into the bore of the receptacle portion to create an interference fit, between the at least one bushing, and the inside diameter of the bore of the receptacle portion; and
wherein the at least two bushing portions are adapted to substantially align the lens barrel along a substantially same axis as the bore of the receptacle portion.

17. The method according to claim 16, further comprising:
providing an aperture through the receptacle portion after the step of pressing; and
injecting an adhesive through the aperture to adhere to the lens barrel to the receptacle portion.

18. The method according to claim 16, wherein the lens barrel has at least two grooves in the outside diameter, wherein the bushing portions are positioned in the grooves.

19. The method according to claim 16, wherein the at least two bushing portions comprise:
a first bushing portion; and
a second bushing portion spaced from the first bushing portion along an axis of the lens barrel.
